(19) United States
(12) Patent Application Publication
(10) Pub. No.: US 2023/0108674 A1
(43) Pub. Date: Apr. 6, 2023

(54) Device and Method for Winding Toroidal Cores

(71) Applicant: RUFF GMBH, Grafing bei München (DE)

(72) Inventor: Alois Hofer, Grafing bei München (DE)

(21) Appl. No.: 17/794,560

(22) PCT Filed: Jan. 20, 2021
(86) PCT No.: PCT/EP2021/051216

§ 371 Date: Jul. 21, 2022

(30) Foreign Application Priority Data
Jan. 21, 2020 (EP) 20152955.9

(51) Int. Cl. H01F 41/08; H01F 41/082; H01F 41/094

(52) U.S. Cl. CPC H01F 41/08; H01F 41/082; H01F 41/094

(57) ABSTRACT

The invention relates to a device and a method for winding toroidal cores arranged on a toroidal core plane with a wire arranged on a winding plane. The device additionally comprises: a protective cover which is arranged substantially on the toroidal core plane and perpendicularly to the winding plane, is movably mounted in a translational manner horizontally on the toroidal core plane, and is designed to be guided over some regions of the toroidal core during operation, and thereby protect the toroidal core, and to produce an inner mold for at least one wire winding, said wire being wound on the mold. The device additionally comprises: a slide which is arranged substantially on the toroidal core plane and parallel to the protective cover and which is slidably mounted about the protective cover, surrounds some regions of the protective cover, and is designed to push the at least one wire winding wound on the protective cover from the protective cover onto the toroidal core during operation by means of a translational movement.

The invention relates to a device and a method for winding toroidal cores arranged on a toroidal core plane with a wire arranged in a winding plane.

A toroidal core winding device with a toroidal core retaining element and an annular magazine, guided through the toroidal core opening, with elements serving to guide the wire and store the wire, is known, for example, from DE 101 53 896 A1. Disadvantageous with this known device is that, when in operation, the wire which is to be wound onto the toroidal core exerts a high loading onto the toroidal core during the production of a wire winding, since the wire is wound directly onto the toroidal core. In particular, with toroidal cores with low material strength and when winding with a thick wire, this can lead to a material failure of the toroidal core.

A further toroidal core winding device with a toroidal core retaining element and a wire guide without a magazine is known, for example, from EP 2 953 149 B1. Disadvantageous with this known device is that, when in operation, the wire which is to be wound onto the toroidal core exerts a high loading onto the toroidal core during the production of a wire winding, since the wire is wound directly onto the toroidal core. In particular, with toroidal cores with low material strength and when winding with a thick wire, this can lead to a material failure of the toroidal core.

The object of the present invention is therefore to provide a device for the winding of toroidal cores and a corresponding winding method which allows for an automated winding of toroidal cores, in particular those with comparatively low material strength. In addition, the device is intended to be simple and robust in design and economical to manufacture.

To solve this object, the invention makes provision for the winding of toroidal cores arranged in a toroidal core plane with a wire, wherein the device comprises a protective cover, which is arranged substantially on the toroidal core plane and perpendicular to the winding plane, and is movably mounted in a translational manner, and is designed, when in operation, to be guided over some regions of the toroidal core, and thereby protect the toroidal core, and to produce an inner mould for at least one wire winding, onto which the wire is wound. The device further comprises a slide, which is arranged substantially on the toroidal core plane and parallel to the protective cover and which is slidably mounted about the protective cover, surrounds some regions of the protective cover, and is designed, when in operation, to push the at least one wire winding wound on the protective cover from the protective cover onto the toroidal core by means of a translational movement.

To solve the object. A method is also proposed for the winding of toroidal cores arranged on a toroidal core plane with a wire arranged on a winding plane. The method comprises in this situation the winding of the wire onto a protective cover and also the following steps: Pushing forwards of a slide and pushing of the at least one wire winding from the protective cover onto the toroidal core, and the pushing back of the slide. In one advantageous embodiment, the method further comprises a step upstream of that described above, being the positioning and braking of the wire which is to be wound by means of guide plates.

The production of a wire winding therefore takes place according to the invention on the protective cover protecting the toroidal core when in operation, in that the protective cover produces an inner mould of at least one wire winding, onto which the wire is wound. In addition, according to the invention the laying of the at least one wire winding wound onto the protective cover takes place by a translational movement of the slide against the wire winding from the protective cover onto the toroidal core. As a result, the loading during the production of the wire winding is borne by the protective cover. Since, as a result, the toroidal core therefore substantially is not subjected to loading during the production of the wire winding, it is also possible for toroidal cores in particular with comparatively low material strength to be wound, and also for wires with comparatively large wire diameters to be wound.

In comparison with a conventional toroidal core (coil) winding device with a wire guide, the device according to the invention is of simple design, since further precautionary measures can be done without, which would otherwise be needed to allow for the winding of toroidal cores with low material strength. Due to the relatively simple design, the device is likewise robust and economical to produce. The method according to the invention therefore also allows for the automated winding of toroidal cores in particular with comparatively low material strength, which cannot be wound with conventional toroidal core (coil) winding devices.

In comparison with conventional toroidal core winding devices with a magazine, the invention is of simple design, since it is possible to do without further precautionary measures which would allow for the winding of toroidal cores with low material strength. Due to the relatively simple design, the device is likewise robust and economical to produce. The method according to the invention therefore also allows for the automated winding of toroidal cores in particular with comparatively low material strength, which cannot be wound with conventional toroidal core (coil) winding devices.

According to one aspect of the invention, the protective cover comprises a receiving region in a region located substantially opposite the face surface of the toroidal core, which is designed to receive a region of the toroidal core which has already been wound with the wire. The receiving region is formed by the geometry of the protective cover between the face surface of the toroidal core and the protective cover, in order to prevent a collision with the partially wound toroidal core when in operation. This allows for the automated winding of the toroidal core. As a result, the process time for winding the toroidal core can be reduced, and the quality of the wound toroidal core can be increased.

According to a further aspect of the invention, the slide comprises a receiving region in a region located substantially opposite the face surface of the toroidal core, which is designed to receive a region of the toroidal core which has already been wound with the wire. The receiving region is formed by the geometry of the slide between the face surface of the toroidal core and the slide, in order to prevent a collision with the partially wound toroidal core when in operation. This allows for the automated winding of the toroidal core. As a result, the process time for winding the toroidal core can be reduced, and the quality of the wound toroidal core can be increased.

According to a further aspect of the invention, the device comprises a first guide plate and a second guide plate, which is arranged substantially parallel to the winding plane and is designed to guide the wire, before the winding onto the protective cover, into a predetermined position in the winding plane and brake it. To produce a wire winding on the protective cover, the wire is preferably guided on the winding plane. Before winding, the wire is guided on the protective cover between the first guide plate and the second guide plate on the winding plane. Due to a resetting force of the second guide plate in the direction of the first guide plate, the wire located in between is braked by friction. As a result, the loading onto the protective cover is reduced during the winding with the wire and a tearing of the wire is prevented. In addition, the quality of the wire winding produced is thereby also increased.

According to a further aspect of the invention, the first guide plate is mounted as stationary, and the second guide plate is mounted on the toroidal core plane such as to be moved horizontally in a translational manner. During the production of the wire winding, the wire comes in contact on the first guide plate and the second guide plate, and moves the second guide plate away from the first guide plate. As a result, the wire is guided between the first guide plate and the second guide plate into a position on the winding plane which is advantageous for the production of a wire winding. This allows for the use of the device with different thicknesses of wire and an increase in the quality of the wire winding produced.

According to a further aspect of the invention, the first guide plate and the second guide plate exhibit in an upper region an inclination angle which continuously increases the distance interval between the first guide plate and the second guide plate, and forms a funnel-shaped wire guidance region. When the wire comes in contact on the first guide plate and the second guide plate, the wire is guided through the funnel-shaped wire guidance region between the first guide plate and the second guide plate onto the winding plate. As a result, the wire is also guided out of a position outside the winding plane into a position advantageous for producing a wire winding between the first guide plate and the second guide plate on the winding plane, and the process reliability is thereby increased.

According to a further aspect of the invention, the second (or also the first or both) guide plate(s) preferably comprise(s) a surface with braking properties, which is designed to brake the wire before the winding onto the protective cover during the guiding of the wire between the guide plates. The braking capacity can be achieved, for example, by the second guide plate comprising a surface made of a material (e.g. felt) with a friction coefficient which is higher than the friction coefficient of the first guide plate. According to further embodiments, the surface of one or both guide plates is correspondingly coated or processed in such a way that the desired friction coefficient is attained. When the wire comes in contact on the first guide plate and the second guide plate, and at the movement of the second guide plate, the wire is braked by the resetting force and the increased friction between the wire and the second guide plate. As a result, both the loading onto the protective cover, as well as the loading onto the first guide plate and the second guide plate, are reduced during the winding with the wire, and a wire tear is prevented. In addition, this increases the quality of the wire winding produced.

According to a further aspect of the invention, the first guide plate and the second guide plate comprises receiving regions which are designed to receive the toroidal core, the protective cover, and the slide. The receiving regions of the first guide plate and of the second guide plate allow for a compact and robust design of the device.

According to a further aspect of the invention, the device comprises at least two drive rollers, with recesses arranged in each case on the face surface of the drive rollers, which are arranged substantially parallel and adjacent to the toroidal core, and are designed to receive wire windings on the toroidal core, and drive the toroidal core rotationally. Due to the parallel and adjacent arrangement of the drive rollers, the toroidal core is mounted stationary when in operation. At least one of the drive rollers is driven in rotation, and when in operation transfers the rotational movement onto the toroidal core. When in operation, the recesses for the drive rollers receive the already wound wire winding on the toroidal core, in order to avoid a collision and also to ensure the rotational movement when the toroidal core has already been partially wound.

According to a further aspect of the invention, the protective cover and the slide are provided in mirror-image on the winding plane. This arrangement allows for the winding of toroidal cores in both directions of rotation, and can therefore reduce the cycle time of the winding.

Exemplary embodiments of the invention are explained in greater detail hereinafter on the basis of the appended Figures. These show:

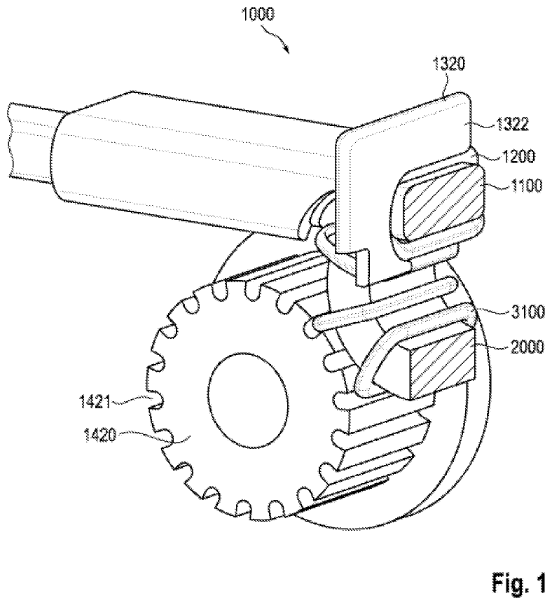

FIG. 1: A rudimentary schematic perspective view of an embodiment of the device for winding toroidal cores, in a sectional view in the winding plane;

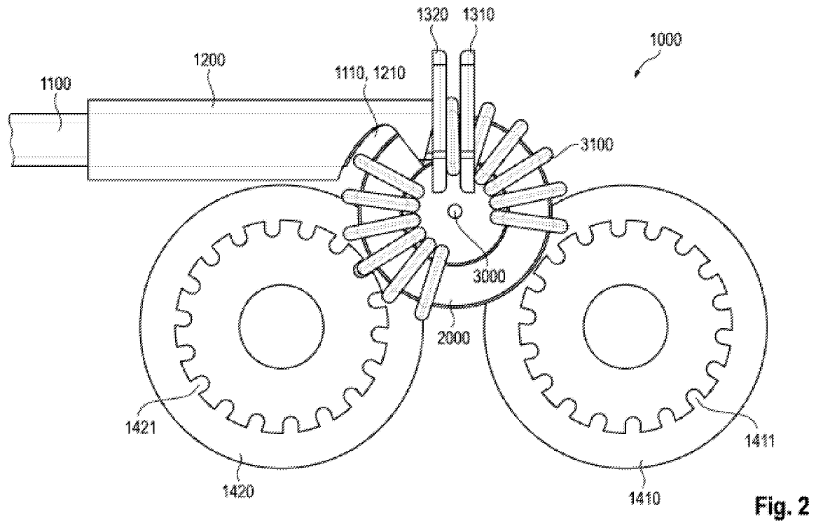

FIG. 2: A rudimentary schematic front view of an embodiment of the device for winding toroidal cores, in a sectional view in the winding plane;

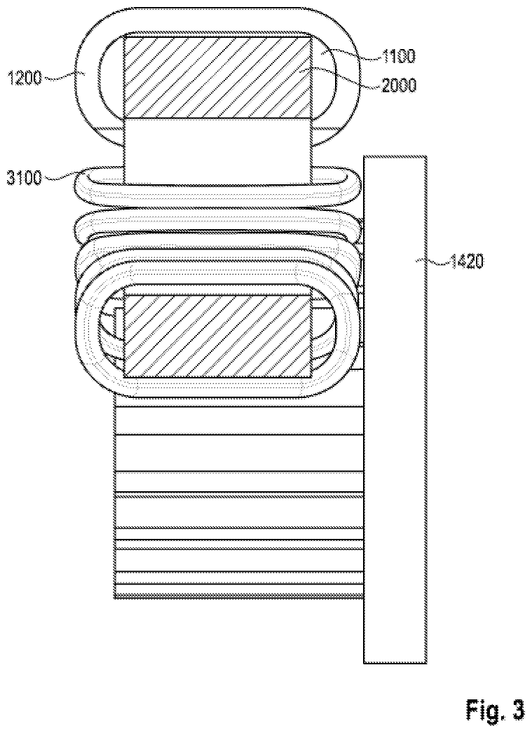

FIG. 3: A rudimentary schematic side view of an embodiment of the device for winding toroidal cores, in a sectional view in the winding plane;

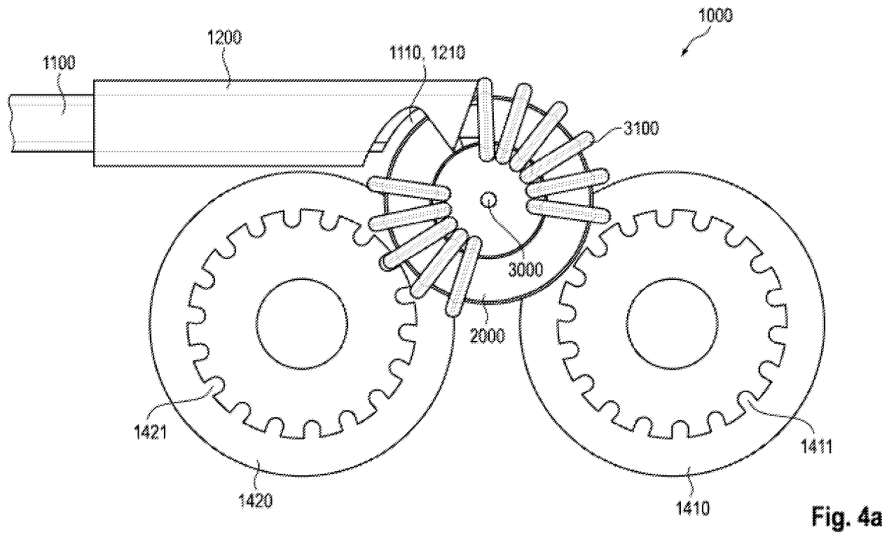

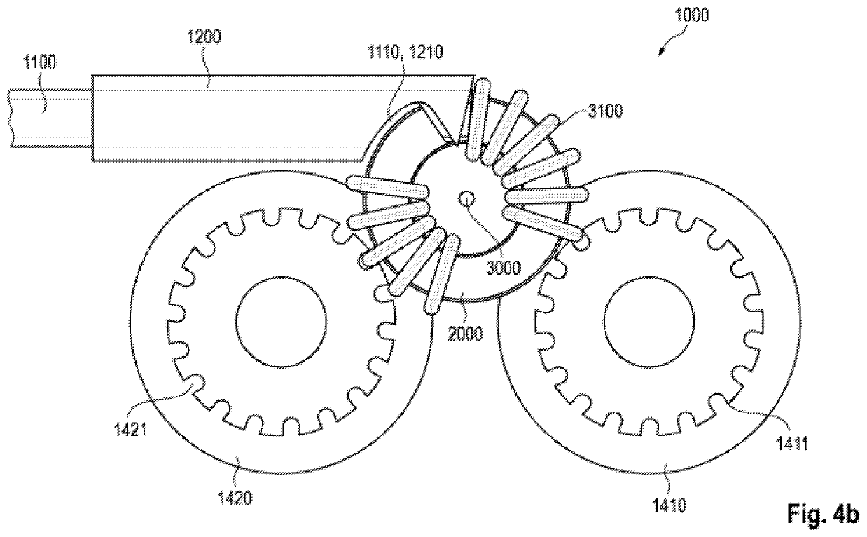

FIG. 4: A rudimentary schematic side view of an embodiment of the device for winding toroidal cores, in a state in which a wire winding is being wound onto the protective cover.

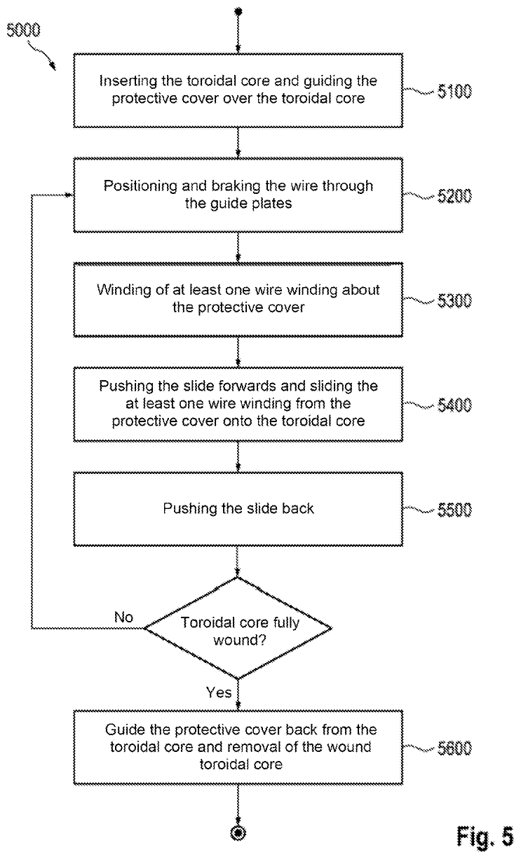

FIG. 5: A rudimentary schematic side view of an embodiment of the device for winding toroidal cores, in a state in which a wire winding is being pushed by the slide from the protective cover onto the toroidal core;

FIG. 5: A flow diagram of a method for winding toroidal cores in accordance with an embodiment of the present invention.

According to the embodiments represented in FIGS. 1 to 4b, the device 1000 for winding toroidal cores 2000 preferably comprises a protective cover 1100, which in operation surrounds and protects sections of the toroidal core 2000. The protective cover 1100 is arranged substantially in the plane of toroidal core 4100 and perpendicular to the winding plane 4200. Moreover, the protective cover is 1100 mounted in the plane of the toroidal core 4100 so as to move horizontally with a translational movement, and can be moved in sections over the toroidal core 2000. As represented in FIG. 3, the region of the protective cover 1100 which when in operation is guided over the toroidal core 2000 exhibits a u-shaped inner shape which corresponds to the outer shape of the toroidal core 2000. The outer shape of the protective cover 1100 corresponds to the inner shape of at least one wire winding 3100. In operation, the protective cover 1100 surrounds the toroidal core 2000 in sections, in order to protect the toroidal core 2000 during the winding with the wire 3000. During the winding, the wire 3000 is wound onto the protective cover 1100. The protective cover 1100 preferably consists of a material with a material strength which is greater than the material strength of the toroidal core 2000.

According to the embodiments represented in FIGS. 1 to 4b, the device 1000 for winding toroidal cores 2000 further comprises a slide 1200, which in operation pushes the at least one wire winding 3100, wound onto the protective cover 1100, from the protective cover 1100 onto the toroidal core 2000. The slide 1200 is in this situation arranged substantially on the toroidal core plane 4100 and parallel to the protective cover 1100, and is mounted so as to slide about the protective cover 1100. As represented in FIG. 3, the inner shape of the slide 1200, which in operation is arranged above the protective cover 1100, corresponds to the outer shape of the protective cover 1100. During the winding of the protective cover 1100, the slide 1200 is located in an initial position, as represented in FIG. 4a. When the at least one wire winding 3100 is wound onto the protective cover 1100, the slide 1200 travels in the direction of the wire winding 3100, and pushes the wire winding 3100 from the protective cover 1100 onto the toroidal core 2000, as represented in FIG. 4b. After the slide 1200 has pushed the at least one wire winding 3100 from the protective cover 1100 onto the toroidal core 2000, the slide 1200 travels back into the initial position, which allows for the further winding of the wire 3000 about the protective cover 1100.

The protective cover 1100 and the slide 1200 comprise recess regions 1110, 1210, which are arranged in a region substantially opposite the face surface of the toroidal core 2000, as represented in FIG. 2. The recess regions 1110, 1210 are designed to receive, in operation, a region of the toroidal core 2000 which has already been wound with the wire 3000. This prevents the already wound region of the toroidal core 2000 from colliding with the protective cover 1100 or the slide 1200 when in operation.

The first and second guide plates 1310, 1320, represented in FIGS. 1 and 2, are arranged substantially parallel and adjacent to the winding plane 4200. The first guide plate 1310 is fixed in position, and the second guide plate 1320 is mounted such as to move horizontally in the toroidal core plane 4100 in a translational manner. The guide plates 1310, 1320 guide the wire 3000 into a predetermined position in the winding plane 4200, and brake the wire 3000 before the winding onto the protective cover 1100. The first guide plate 1310 and the second guide plate 1320 exhibit inclinations in an upper region 1330, which continuously increase the distance interval between the first guide plate 1310 and the second guide plate 1320, and form a funnel-shaped wire opening region 1340. When the wire 3000 comes in contact on the first guide plate 1310 and the second guide plate 1320, the wire 3000 is guided through the funnel-shaped wire opening region 1340 by the pushing of the second guide plate 1320 between the first guide plate 1310 and the second guide plate 1320. The wire 3000 is therefore guided out of a position outside the winding plane 4200 into a position on the winding plane 4200 advantageous for producing at least one wire winding 3100. The wire 3000 is guided in this situation between the first guide plate 1310 and the second guide plate 1320 into a position on the winding plane 4200 advantageous for producing the wire winding 3100.

The braking of the wire 3000 between the first guide plate 1310 and the second guide plate 1320 takes place on the one hand due to a resetting force which takes effect from the second guide plate 1320 in the direction of the second guide plate 1310. The wire 3000 located in between is pressed by the second guide plate 1320 against the first guide plate 1310, and, as a result, is braked when the wire 3000 is guided between the two guide plates 1310, 1320. On the other hand, the second guide plate 1320 exhibits, according to one embodiment of the present invention, a surface 1322 with braking properties, made of a material (e.g. with a brake covering such as felt or similar) with a friction coefficient which is greater than the friction coefficient of the first guide plate 1310, as represented in FIG. 1. Between the first guide plate 1310 and the second guide plate 1320, the wire 3000 is accordingly also braked due to the surface 1322 with increased friction, with braking properties, between the wire 3000 and the second guide plate 1320. In further embodiments, the guide plate 1310, or both guide plates 1310, 1320, can also be moved in a translational manner. In addition, in further embodiments, the first guide plate 1310 or both guide plates 1310, 1320 can also comprise a surface 1322 with braking properties,

As represented in FIG. 2, the device 1000 comprises, according to a further embodiment, at least two drive rollers 1410, 1420, in each case with recesses 1411, 1421 arranged on the face surface of the drive rollers 1410, 1420. The drive rollers 1410, 420 are arranged with their face surface in rotational contact with the toroidal core 2000 during the winding. The recesses 1411, 1421 of the drive motors 1410, 1420 are designed so as to receive, in operation, the wire windings 3100 already wound onto the toroidal core 2000. As a result, it is ensured that the drive rollers 1410, 1420 will not collide with the wire windings 3100 wound onto the toroidal core 2000, and the rotational movement is then also transferred onto the toroidal core 2000 when the toroidal core 2000 has already been partially wound.

According to one embodiment, the method 5000 for winding toroidal cores 2000 can be compiled as described hereinafter, by reference to FIGS. 4a, 4b, and 5. The toroidal core 2000 is placed in the device 1000 and rotated during the winding. Next, the protective cover 1100 is guided over some sections of the toroidal core 2000, as a result of which the toroidal core 2000 is mounted stationary and also rotationally movable, due to the drive rollers 1410, 1420 and the protective cover 1100, in a preferred position in the device 1000. After this, the first wire winding 3100 is wound onto the protective cover 1100, as represented in FIG. 4a. After the first wire winding 3100 has been wound onto the protective cover, the slide 1200 travels in the direction of the wire winding 3100, and pushes this from the protective cover 1100 onto the toroidal core 2000. Next, the slide 1200 travels back into its original position. These steps are then repeated until a predetermined desired number of wire windings 3100 has been wound onto toroidal core 2000.

According to a further embodiment, the method 5000 for winding toroidal cores 2000 can further comprise, in addition to the steps described heretofore, a preliminary step of positioning and braking of the wire 3000 which is to be wound by means of guide plates 1310, 1320. When the wire 3000 comes in contact onto the first guide plate 1310 and the second guide plate 1320, the wire 3000 is guided through the funnel-shaped wire opening region 1340 between the first guide plate 1310 and the second guide plate 1320. The guide plates 1310, 1320 guide the wire 3000 into a predetermined on the winding plane 4200 and brake the wire 3000 before the winding onto the protective cover 1100.

FIG. 5 shows a flow diagram of an embodiment of a method 5000 for the winding of toroidal cores 2000 in accordance with one embodiment of the present invention. According to step 5100, the toroidal core 2000 is placed into the device 1000 before the winding. The protective cover 1100 is guided over the toroidal core 2000, as a result of which the toroidal core 2000 is mounted such as to be stationary but rotationally movable due to the drive rollers 1410, 1420 and the protective cover 1100. According to a further step 5200, the wire 3000 which is to be wound is positioned and braked by the guide plates 1310, 1320 on the winding plane 4200. According to a further step 5300, at least one wire winding 3100 is wound onto the protective cover 1100. According to a further step 5400, the slide 1200 is moved in the direction of the wire winding 3100 wound onto the protective cover 1100, and, as a result, the slide 1200 pushes the at least one wire winding 3100 from the protective cover 1100 onto the toroidal core 2000. According to a further step 5500, the slide 1200 then travels back into its original position. If, after step 5500, the toroidal core 2000 exhibits a desired predetermined number of wire windings 3100, then, according to a further step 5600, the protective cover 1100 is moved back from the toroidal core 2000, and the wound toroidal core 2000 is removed. If, after step 5500, the toroidal core 2000 does not yet exhibit the predetermined desired number of wire windings 3100, then the steps 5200, 5300, 5400, 5500 are then repeated for as long as required until the toroidal core 2000 does exhibit the predetermined desired number of wire windings 3100.

In the meaning of the invention, the term toroidal core also includes tubular cores or cores with special opening geometries, and relates in particular to such toroidal cores with small inner diameters or cores with angled opening geometries, as well as tubular cores which, due to their dimensions cannot be wound with conventional toroidal core winding devices, since the magazine cannot be guided through the toroidal core opening due to the space required for the magazine. The embodiments described here are, however, likewise well-suited for the winding of other toroidal cores or cores with other openings, and also such with larger inner diameters, and allow for simple and convenient winding.

In the meaning of the invention, the term wire also includes all other materials with which, in a rational manner, toroidal cores or similar objects are to be wound in accordance with the invention.

Further advantageous embodiments and derivations derive for the person skilled in the art from the exemplary embodiments described here, and will be understood by him as belonging to the invention.

1. Device for winding toroidal cores arranged on a toroidal core plane, with a wire arranged on a winding plane, comprising:
a protective cover, which is arranged substantially on the toroidal core plane and perpendicular to the winding plane and is mounted on the toroidal core plane such as to be movable horizontally in a translational manner, and is designed such as to be guided, in operation, in some sections over the toroidal core, and therefore protect the toroidal core, and to produce an inner mould of at least one wire winding, onto which the wire is wound,
a slide, which is arranged substantially on the toroidal core plane and parallel to the protective cover and mounted such as to slide about the protective cover and in some sections surrounds the protective cover, and is designed so as to push the at least one wire winding wound onto the protective cover, when in operation, by a translational movement from the protective cover onto the toroidal core.

2. Device for winding toroidal cores according to claim 1,
wherein the protective cover comprises a receiving region in a region located substantially opposite the face surface of the toroidal core, which is designed such as to receive a region of the toroidal core which has already been wound with the wire.

3. Device for winding toroidal cores according to claim 2,
wherein the slide comprises a receiving region in a region located substantially opposite the face surface of the toroidal core, which is designed to receive a region of the toroidal core which has already been wound with the wire.

4. Device for winding toroidal cores according to claim 1,
wherein the device comprises a first guide plate and a second guide plate, which are arranged substantially parallel to the winding plane and are designed to guide the wire before the winding onto the protective cover into a predetermined position on the winding plane and to brake it.

5. Device for winding toroidal cores according to claim 4,
wherein the first guide plate is mounted in a fixed position, and the second guide plate is mounted on the toroidal core plane and is movable horizontally in a translational movement.

6. Device for winding toroidal cores according to claim 4,
wherein the first guide plate and the second guide plate exhibit an inclination in an upper region, which continuously increases the distance interval between the first guide plate and the second guide plate, and forms a funnel-shaped wire guiding region.

7. Device for winding toroidal cores according to 4,
wherein the second guide plate comprises a surface with braking properties, which is designed such as to brake the wire before the winding onto the protective cover.

8. Device for winding toroidal cores according to claim 4,
wherein the first guide plate and the second guide plate comprise receiving regions, which are designed to receive the toroidal core, the protective cover, and the slide.

9. Device for winding toroidal cores according to claim 1,
wherein the device comprises at least two drive rollers, in each case with recesses arranged on the face surface of the drive rollers, which are arranged substantially parallel and adjacent to the toroidal core, and are designed to receive wire windings on the toroidal core, and drive the toroidal core rotationally.

10. Device for winding toroidal cores according to claim 1,
wherein the protective cover and the slide are arranged as doubled in mirror image on the winding plane.

11. Method for winding a toroidal core arranged on a toroidal core plane, with a wire arranged on a winding plane, wherein the method comprises the following steps:
a. Winding at least one wire winding onto the protective cover;
b. pushing forward a slide and pushing the at least one wire winding from the protective cover onto the toroidal core; and
c. pushing back the slide.

12. Method for winding toroidal cores in accordance with claim 11, wherein the toroidal core is driven rotationally when in operation by the at least two drive rollers and rotates in the toroidal core plane.

13. Method for winding toroidal cores in accordance with claim 11, wherein the method comprises a step upstream of step a., with the positioning and braking of the wire which is to be wound by means of guide plates.

14. Method for winding toroidal cores in accordance with claim 11, wherein, at the beginning of the method, the toroidal core is placed in the device and the protective cover is guided in sections over the toroidal core; and wherein the steps a. to c. are run through repeatedly in order to wind the desired number of wire windings onto the toroidal core.

15. Method for winding toroidal cores in accordance with claim 11, wherein the method is carried out using the device for winding toroidal cores.
